(19) United States
(12) Patent Application Publication
(10) Pub. No.: US 2014/0258886 A1
(43) Pub. Date: Sep. 11, 2014

(54) METHOD FOR TRANSFERRING A FILE FROM A DEVICE

(71) Applicant: SMUGMUG, INC., Mountain View, CA (US)

(72) Inventor: Brian STRONG, San Jose, CA (US)

(21) Appl. No.: 14/199,678

(22) Filed: Mar. 6, 2014

Related U.S. Application Data
(60) Provisional application No. 61/774,346, filed on Mar. 7, 2013.

(51) Int. Cl. H04L 29/06; G06F 3/01

(52) U.S. Cl. CPC H04L 65/403; G06F 3/017
USPC 715/753

(57) ABSTRACT

Embodiments described herein generally relate to methods for transferring a file from a device to other storage/display locations. As the device displays a file, the file may be transferred to one or more destinations by detecting a gesture on the display screen. Alternatively, a plurality of destinations may be displayed for a user's selection after detecting the gesture on the display screen. As the user selects a destination, the displayed file is transferred to the selected destination.

### CROSS-REFERENCE TO RELATED APPLICATIONS

This application claims benefit of U.S. provisional patent application No. 61/774,346, filed Mar. 7, 2013, which is hereby incorporated by reference.

### BACKGROUND

1. Field

Embodiments described herein relate to a system and method for transferring files from a device.

2. Description of the Related Art

The popularity of electronic devices, such as smart phones and tablets, has substantially increased in recent years. These devices are capable of handling many types of files, such as word processors, spreadsheets, photos, music, videos and many others. In addition, the devices can also generate files such as photos and videos since most of the devices include at least one camera. As a result, the need to transfer files from a device to other storage/display locations has also increased. The storage/display locations may be physical devices such as desktop or laptop computers, or may be virtual locations such as websites or cloud storage. Traditionally, transferring a file from a device may require multiple steps. A user may email a file from the device and then retrieve the email on a difference device, such as a laptop computer. Emailing requires the user to enter the email address of the recipient and to attach the file to the email. The user may also transfer a file by uploading the file on a website, such as a social network website, which requires the user to log on to the website and then go through the steps such as attaching the file and uploading the file.

Therefore there is a need for an improved method to transfer files from a device.

### SUMMARY

Embodiments described herein generally relate to methods for transferring a file from a device to other storage/display locations. As the device displays a file, the file may be transferred to one or more destinations by detecting a gesture on the display screen. Alternatively, a plurality of destinations may be displayed for a user's selection after detecting the gesture on the display screen. As the user selects a destination, the displayed file is transferred to the selected destination.

In one embodiment, a method for transferring a file from a device is disclosed. The method comprises displaying a file on a screen of the device, detecting a gesture on the screen, and sending the file to a destination in response to the detecting.

In another embodiment, a method for transferring a file from a device is disclosed. The method comprises displaying a file on a screen of the device, detecting a gesture on the screen, displaying a plurality of destinations on the screen in response to the detecting, detecting a selection of one of the destinations, and sending the file to the selected destination.

In another embodiment, a non-transitory computer readable storage medium stores instructions that, when executed by a processor, cause the processor to transfer a file to a destination, by performing the steps of displaying the file on a screen of a device, detecting a gesture on the screen, and sending the file to a destination in response to the detecting.

In another embodiment, a non-transitory computer readable storage medium stores instructions that, when executed by a processor, cause the processor to transfer a file to a destination, by performing the steps of displaying the file on a screen of a device, detecting a gesture on the display screen, displaying a plurality of destinations on the screen in response to the detecting, detecting a selection of one of the destinations, and sending the file to the selected destination.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a device according to one embodiment.

FIGS. 2A-2E illustrate a method for transferring a file from a device according to one embodiment.

FIGS. 3A-3D illustrate a method for transferring a file from a device according to another embodiment.

FIG. 4 is a flow diagram of method steps for transferring a file from a device according to one embodiment.

FIG. 5 is a flow diagram of a method for transferring a file from a device according to another embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following description, several specific details are presented to provide a thorough understanding of embodiments of the invention. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

Embodiments described herein generally relate to methods for transferring a file from a device to other storage/display locations. As the device displays a file, the file may be transferred to one or more destinations by detecting a gesture on the display screen. Alternatively, a plurality of destinations may be displayed for a user's selection after detecting the gesture on the display screen. As the user selects a destination, the displayed file is transferred to the selected destination.

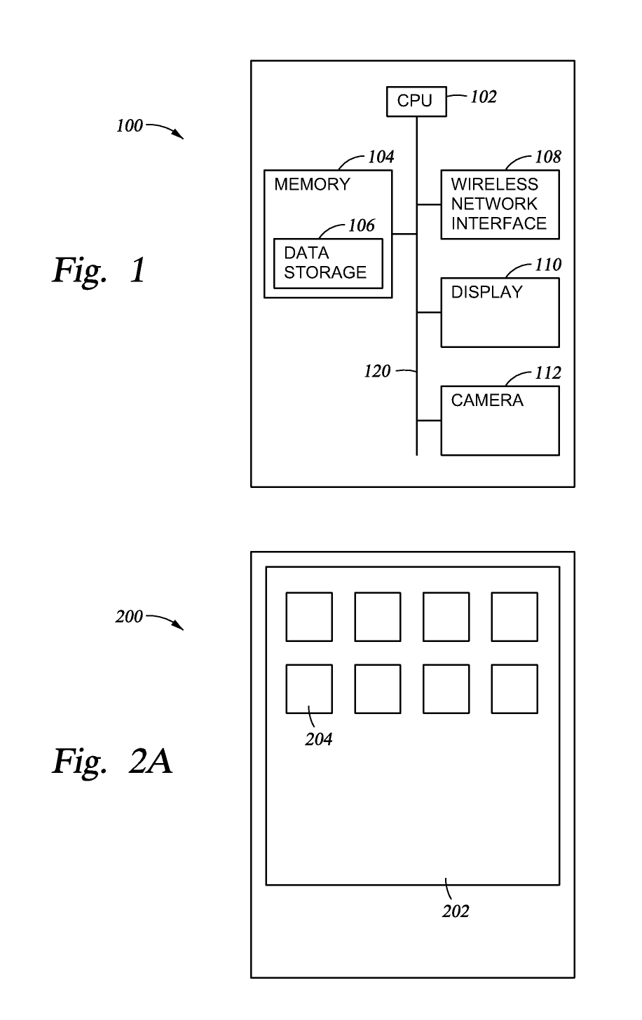

FIG. 1 shows a device 100 that may be utilized to implement the embodiments described herein. The device 100 may contain more or less components than those shown in FIG. 1. The components shown in FIG. 1 are pertinent to the embodiments of the invention. The device 100 comprises a central processing unit (CPU) 102, a memory 104, a storage 106, a wireless network interface 108, and a display 110. The device 100 may further include a camera 112. The CPU 102 is in communication with all components via an interconnect bus 120.

The CPU 102 generally controls and coordinates operations of all components within the device 100 by retrieving and executing programming instructions stored in the memory 104. The CPU 102 also stores and retrieves application data residing in the memory 104. The CPU 102 may be any type known in the art, such as a single CPU, multiple CPUs, or a single CPU having multiple processing cores. Programming instructions and application data are transmitted from the CPU 102 to the memory 104, storage 106, wireless network interface 108 and display 110 by the interconnect bus 120.

The memory 104 stores software applications and data for use by the CPU 102. The memory 104 may be a flash memory, a random access memory (RAM), a read-only memory (ROM), or any other memory known in the art. The memory 104 also includes a data storage 106 for storing various data. The data storage 106 may be a primary data storage that is part of the device 100. There may be one or more secondary data storages coupled to the device 100 to increase the storage capacity of the device 100. Secondary data storages are external to the device 100, such as secure digital (SD) cards. The device 100 may also store data virtually, such as using cloud storage.

The device 100 may communicate with other devices or one or more networks via the wireless network interface 108. The other devices may be a mobile device or a stationary device. The networks may be a local computer network or a mobile network. Data is exchanged between the device 100 and the various networks through one or more communication protocols and technologies, including but not limited to, Institute of Electrical and Electronics Engineers (IEEE) 802.11 (Wi-Fi), Bluetooth, global system for mobile communication (GSM), code division multiple access (CDMA), Enhanced Data Rate for GSM Evolution (EDGE), 3^{rd} Generation (3G), or Long Term Evolution (4G LTE).

The display 110 of the device 100 is used to display information in terms of text, graphics, animation and video. The display 110 may be a liquid crystal display (LCD), light emitting diode (LED), organic light emitting diode (OLED), or any other type of display known in the art. In addition, the display 110 may be a touch screen display that receives inputs by detecting the presence and the location of a touch within the display area. The touching may be performed with a finger, a stylus, or any object known in the art. The touching may be a simple tap, a swipe, or a gesture. The gesture includes motions made by one or more fingers.

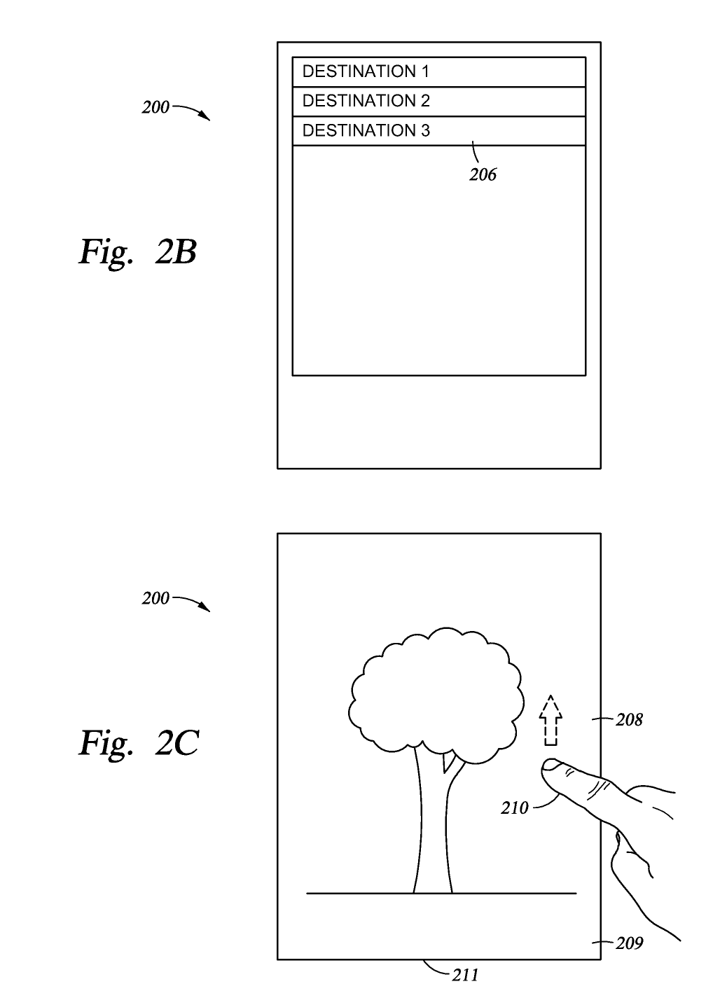

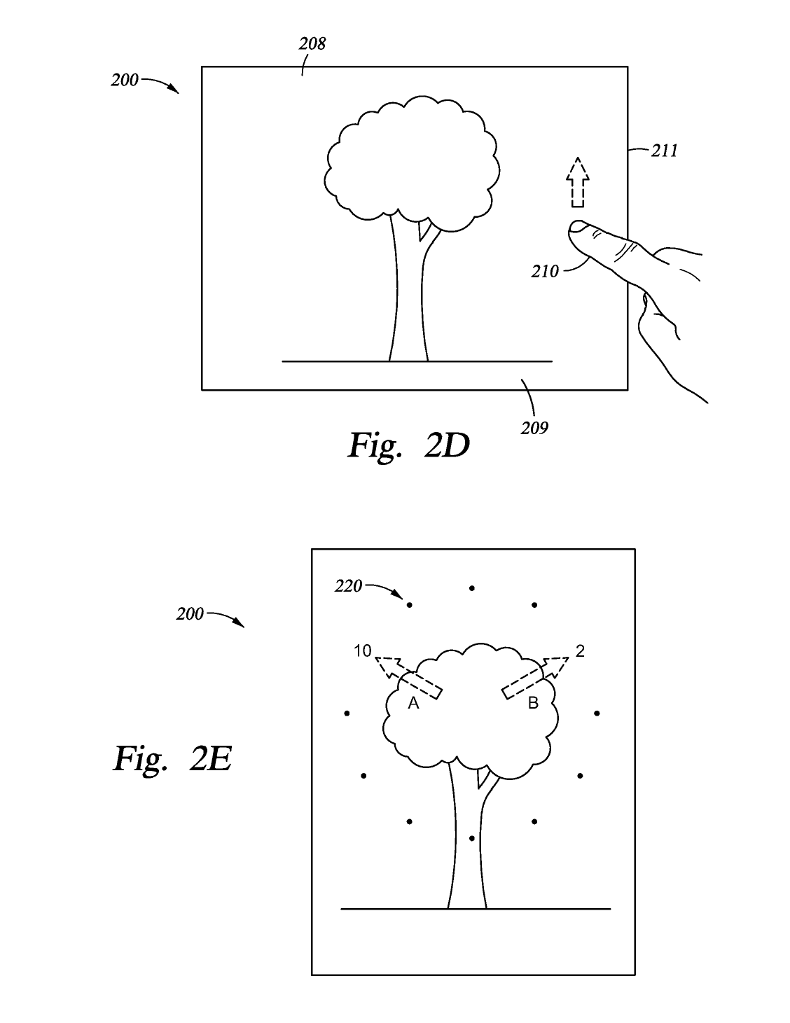

The device 100 sometimes utilizes a software program, or an application, for the transferring of a file from the device 100 to various destinations. The application may be pre-installed on the device 100 during manufacture, or downloaded by a user after obtaining the device 100. The application may be incorporated in other applications. In one embodiment, the application is downloaded to the device 100 from one of many application distribution platforms. The application is capable of transferring a file from the device 100 to a destination using several methods. FIGS. 2A-2E illustrate one method for such file transferring.

FIG. 2A depicts a device 200 having an application 202 running. The application 202 is stored in the data storage 106 and executed by the CPU 102 described in FIG. 1. There are several ways for the device 200 to obtain the application 202. The application 202 may be pre-installed during the manufacturing of the device 200, or the application 202 may be downloaded to the device 200 via one of many application distribution platforms such as Apple® App Store or Google Play®. The application 202 functions just like a software program on a computer once the application 202 is downloaded and installed on the device 200. The application 202 is capable of transferring a file to a destination by receiving an input signal from the device 200 in which the application 202 is stored or from a different device. One example of receiving an input signal is detecting certain motion or motions performed on the screen of the device 200 in which the application 202 is stored. Another example of receiving an input signal is detecting a sound or human voice. The input signal may also be a gesture captured by a camera incorporated on the device 200. In one embodiment, the application 202 is used for taking photos, storing photos, edit photos and transfer photos. Typically the application 202 is displayed as an icon on the screen of the device 200, and a user may launch the application 202 by tapping on the icon. Once the application 202 is launched, the user may perform a pre-selection of one or more destinations for a file to be transferred to. The user may go to “settings” of the application to select one or more destinations from a plurality of destinations.

The application 202 displays the plurality of destinations 204 on the screen of the device 200 for the user to select. The destination 204 may be any location where data can be stored and/or displayed, such as a different storage location on the same device 200, a mobile device, a display device such as a television, a social network website, or a cloud storage location. One of the destinations may be multiple destinations set by the user. The destination 204 may be selected as the user taps on the destination. FIG. 2B shows an alternative design of displaying the destinations 204. The destinations are displayed as a list 206. In one embodiment, only one destination is shown, and as the user taps on the displayed destination, a drop-down list 206 showing a plurality of destinations is displayed. The user then may select a destination from the list 206. In addition to tapping on the destination, the user may select destinations by any method known in the art. Additionally, the destination may be preselected in the application prior to sending the file to any destination. For example, the application may be opened and the predetermined locations are selected, even if the predetermined locations are third party services. By predetermining the destinations and taking any steps necessary to arranged for the destination to receive the files, the application is ready for operation.

The destination may be selected once for all subsequent file transfers, or may be selected every time a file needs to be transferred. At any time after the destination is selected, the user may transfer a displayed file to the selected destination by performing one or more gestures on the screen, which is described in detail below. However, it is to be understood that the destination does not have to be selected prior to displaying the file. In one embodiment, the file may be displayed first, and then the destination is selected. The file may be any file capable of being displayed on a device, including but not limited to, text, photo, animation, and video. A music file may be displayed by its title, description, or album cover.

FIG. 2C illustrates the device 200 showing a displayed image 208. The displayed image 208 may be a text file, a photo file, an animation file, a music file, or a video file. In one embodiment, as shown in FIG. 2C, the displayed image 208 is a photo file. The device 200 has a bottom 211 and the displayed image 208 has a bottom 209. In order to transfer the displayed image 208 to the selected destination, the user may perform a gesture on the displayed image 208 with one or more fingers 210. In one embodiment, the gesture is a swiping motion. The performance of the swiping motion may not be limited to by the finger 210. A toe or a knuckle may also perform the swiping motion. The length of the swiping motion may range from a very small length representing the slightest movement of the finger 210 to a length crossing the entire display screen. The swiping motion may be performed on any location of the displayed image 208 in any direction. In one embodiment, the swiping motion starts from a location near the bottom 209 of the displayed image and moves away from the bottom 209. As shown in FIG. 2C, the bottom 209 of the displayed image 208 is the same as the bottom 211 of the device 200. However, this is not always the case. In FIG. 2D, the device 200 is rotated 90 degrees and is placed in a horizontal position displaying the photo 208. The bottom 209 of the displayed image 208 now no longer corresponds to the bottom 211 of the device 200. The swiping motion performed by the finger 210 starts from the bottom 209 of the displayed image 208 and moves away from the bottom 209, and the swiping motion is not relative to the bottom 211 of the device 200.

FIG. 2E illustrates another embodiment. In this embodiment, the direction of the swiping motion dictates the destination to which the file is to be transferred. As shown in FIG. 2E, for the purpose of presenting directions, an invisible analog clock 220 is superimposed on the screen of the device 200. If the swiping motion is performed from the middle of the clock 220 towards the 2 o'clock location, as indicated by arrow “A”, the displayed file would go to a first destination. If the swiping motion is performed from the middle of the clock towards the 10 o'clock location, as indicated by arrow “B”, the displayed file would go to a second destination different from the first destination. The directions and the corresponding destinations may be pre-selected in the “settings” of the application 202, and the directions are not limited to the 2 o'clock or 10 o'clock locations. Although FIGS. 2C, 2D and 2E all illustrate a swiping motion, the transferring of the file may be performed by other gestures.

As the screen detects the gesture, such as a swiping motion, the displayed file is transferred to the pre-selected destination via the wireless network interface described in FIG. 1. The wireless network interface serves to couple the device 200 to a network in which data may be transmitted. The network may be a local computer network, and the file is transferred from the device 200 to one of the computers in the local computer network. The network may be a mobile network provided by one or more mobile carriers such as AT&T® or Verizon®, and the file is transferred from the device to a mobile device coupled to the network or to one or more websites. The displayed file may be transferred to the pre-selected destination without the wireless network interface described in FIG. 1. For a destination that is located on the same device 200, the displayed file may be transferred via the application 202.

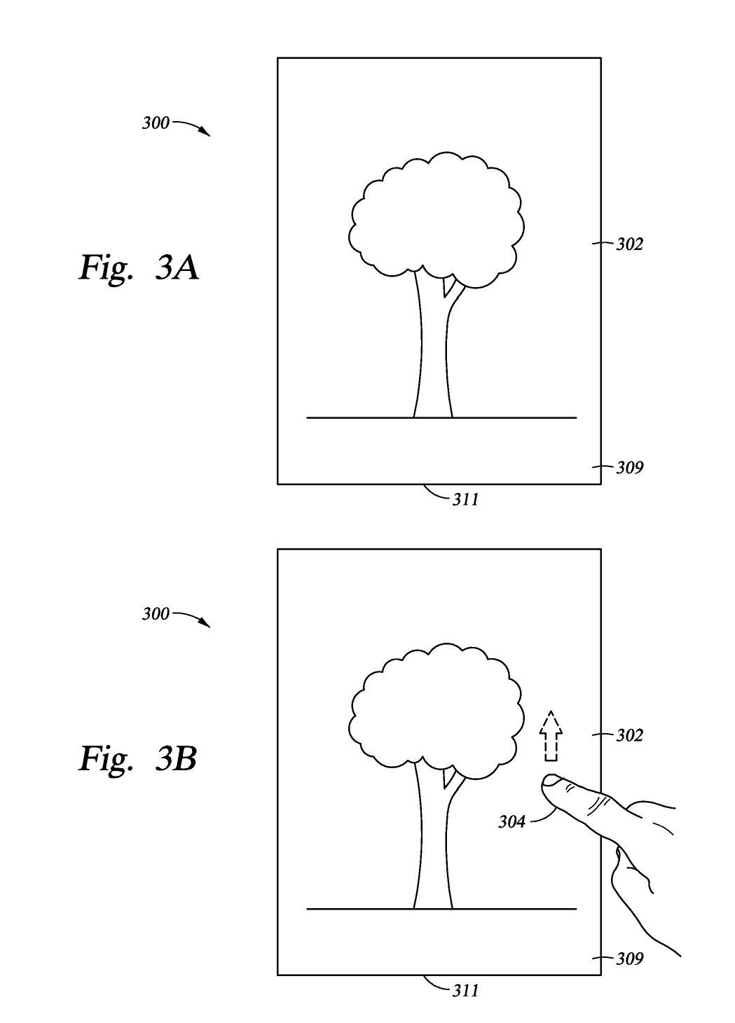

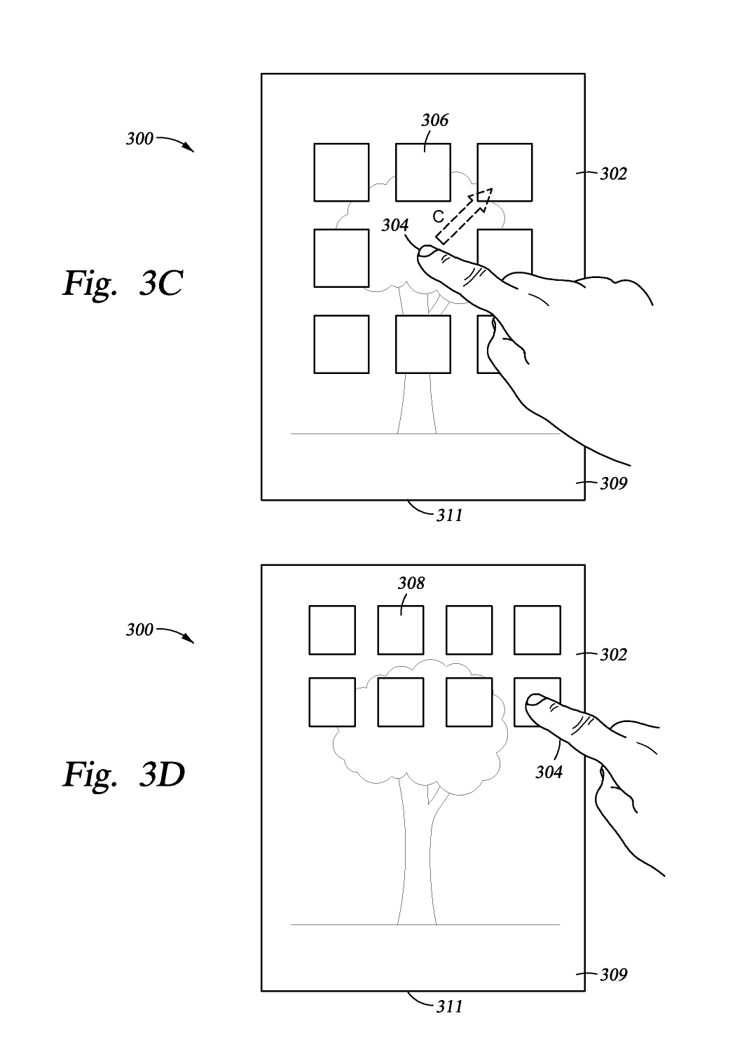

FIGS. 2A-2E illustrate a method for transferring a file in which a gesture, such as a swiping motion, transfers displayed file on the device to a pre-selected destination. FIGS. 3A-3D illustrate a different method for transferring a file from a device according to another embodiment. This method also has steps of pre-selecting the destinations, as described above. The method described below may be performed at any time after the pre-selection. FIG. 3A shows a device 300 having a displayed image 302. The displayed image 302 may be a text file, a photo file, an animation file, a music file, or a video file. In one embodiment, as shown in FIG. 3A, the displayed image 302 is a photo file. The photo file may be displayed using the application 202 described in FIG. 2A. Alternatively, the photo file may be displayed using a default display application of the device 300 and the application 202 is incorporated into the default display application.

As shown in FIG. 3B, to transfer the photo file, the user may perform a gesture anywhere on the displayed image 302 with one or more fingers 304. In one embodiment, the gesture is a swiping motion. Again the swiping motion may be performed with body parts other than the finger 304, such as a toe or a knuckle. The length of the swiping motion may range from a very small length representing the slightest movement of the finger 304 to a length crossing the entire display screen. The swiping motion may be performed on any location of the displayed image 302 in any direction. In one embodiment, the swiping motion starts from a location near the bottom 309 of the displayed image 302 and moves away from the bottom 309. Again the bottom 309 of the displayed image may or may not correspond to the bottom 311 of the device 300, depending on the orientation of the device 300.

In response to the detecting the swiping motion on the displayed image 302, a plurality of destinations 306 are displayed, as shown in FIG. 3C. The plurality of destinations 306 have been pre-selected in the “settings” of the application by the method described above. As the destinations 306 are displayed, the displayed image 302 fades into the background. One of the destinations 306 may include multiple destinations previously set by the user. The destinations 306 may be displayed in the periphery of the display screen, leaving an open space in the middle of the display screen. Once the destinations 306 are displayed, the user may perform a swiping motion starting from the open space in the middle of the display screen and moving towards the destination to which the file is going to be transferred, as indicated by an arrow “C” in FIG. 3C. The swiping motion in FIG. 3B and the swiping motion in FIG. 3C may be one continuous motion, meaning the finger 304 does not leave the display screen between the two swiping motions. Although FIGS. 3B and 3C both illustrate a swiping motion, the transferring of the file may be performed by other gestures.

FIG. 3D illustrates an alternative display of the plurality of destinations 308 in response to the swiping motion described in FIG. 3B. The plurality of destinations 308 may have been pre-selected in the “settings” of the application by the method described above. In one embodiment, the destinations 308 are displayed in rows and each row has multiple destinations. The user may select the destination by tapping on the desired destination. Again, one of the destinations 308 may include multiple destinations. The destinations 308 may be displayed in various formats such as a list or a drop-down list.

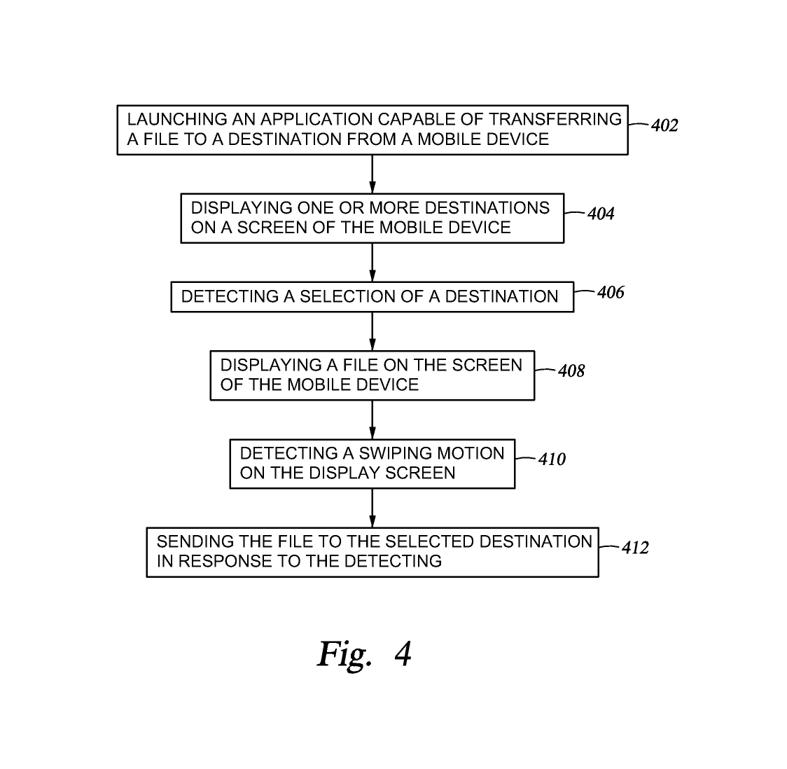

FIG. 4 is a flow diagram of method steps for transferring a file from a device according to one embodiment of the invention. At operation 402, an application capable of transferring a file to a destination from a device is launched by a user using the device. The application may be pre-installed on the device during manufacturing, or downloaded from one of many application distribution platforms after the device is obtained by the user. One example of the latter is an application developed by SmugMug, which is available for download at multiple application distribution platforms such as Apple® App Store or Google Play®.

At operation 404, the application receives an input from the user to display one or more destinations on a screen of the device. Usually the user goes into the “settings” of the application to bring up the one or more destinations. The destinations may be any location where a file can be stored and/or displayed. The destination may be one of the following: a different location on the same device, a mobile device, a desktop computer, a television, a social network website, a cloud storage location, or any location known in the art. The destinations are displayed as icons, each representing one or more destinations. The destinations may be displayed as a list or a drop down list.

At operation 406, one or more destinations are selected by the user. The selection may be done by tapping on the icon representing the destination or by tapping on the name of the destination on the list. The selection may be done by any method of making a selection on a touch screen known in the art. Once the one or more destinations are selected, the selection may remain in the application as the default for all subsequent file transfers until the user decides to select new destinations. Alternatively, the selection of the one or more destinations may be performed for each file transfer.

At operation 408, a file is displayed on the screen of the device at any time after the one or more destinations have been selected. The file may be a text file, a photo file, an animation file, a video file, or a music file, and may be stored in a primary data storage that is part of the device. Alternatively, the file may be stored in a secondary data storage such as a SD card that is plugged into the device or a cloud storage location. The file may be displayed by the application launched in operation 402, or by a display application not capable of transferring the displayed file to various destinations. In the latter case, the transfer application launched in operation 402 is incorporated in the display application to transfer the displayed file to various destinations. Launching the display application simultaneously launches the file transfer application. The screen of the device may be a touch screen that receives inputs by detecting the presence and the location of a touch within the display screen.

At operation 410, a gesture on the display screen is detected. In one embodiment, the gesture is a swiping motion. The swiping motion may be performed by a finger, or other body parts such as a knuckle or a toe. An object such as a stylus may be used to perform the swiping motion. The length of the swiping motion may range from a very small length representing the slightest movement of the finger to a length crossing the entire display screen. The swiping motion may be performed on any location of the displayed image in any direction. In one embodiment, the swiping motion starts from a location near the bottom of the displayed image and moves away from the bottom. The bottom of the displayed image may not always be the bottom of the device. As the device is rotated 90 degrees, the displayed image does not rotate with the device, thus the bottom of the displayed image is now corresponding to one of the two sides of the device. The swiping motion may be detected in relation to the bottom of the displayed image and not in relation to the bottom of the device. In one embodiment, the direction of the swiping motion dictates the destination to which the file is to be transferred.

At operation 412, the file that is being displayed on the screen of the device is transferred to the one or more destinations selected in operation 406 in response to the detecting of the swiping motion in operation 410. Depending on the nature of the destination, the file may be transferred to a physical or virtual location, or may be transferred and displayed on a website such as a social network website. The file may be transferred to the destination via one of many protocols or technologies. These protocols and technologies include but not limited to Wi-Fi, Bluetooth, GSM, CDMA, EDGE, 3G, or 4G LTE. As a result, the file is transferred from a device to a destination via a gesture, such as an one-swipe motion.

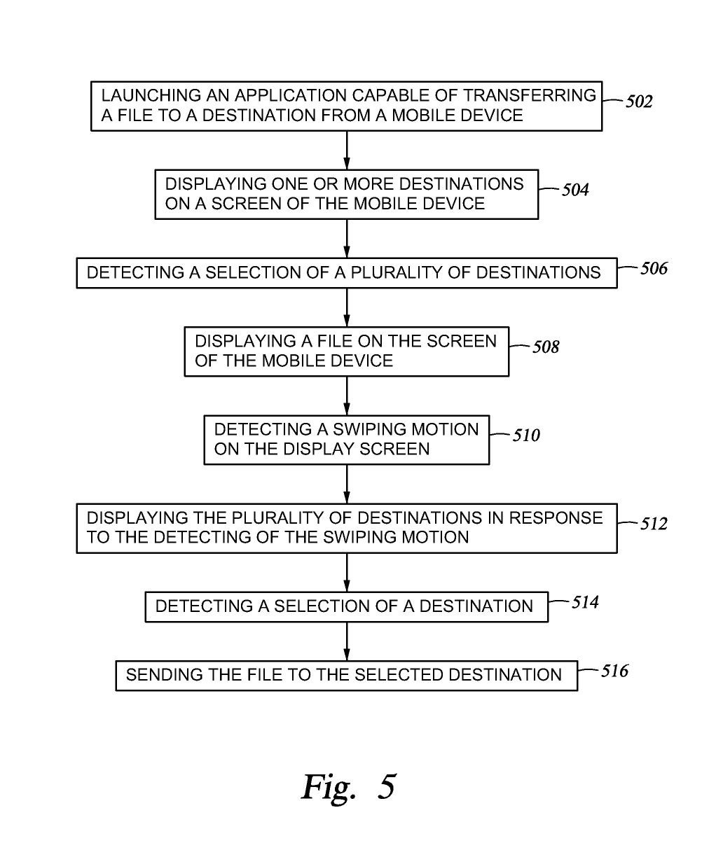

FIG. 5 is a flow diagram of method steps for transferring a file from a device according to another embodiment of the invention. At operation 502, an application capable of transferring a file to a destination from a device is launched by a user using the device. The application may be pre-installed on the device during manufacturing, or downloaded from one of many application distribution platforms after the device is obtained by the user. One example of the latter is an application developed by SmugMug, which is available for download at multiple application distribution platforms such as Apple® App Store or Google Play®.

At operation 504, the application receives an input from the user to display one or more destinations on a screen of the device. Usually the user goes into the “settings” of the application to bring up the one or more destinations. The destinations may be any location where a file can be stored and/or displayed. The destination may be one of the following: a different location on the same device, a mobile device, a desktop computer, a television, a social network website, a cloud storage location, or any location known in the art. The destinations are displayed as icons, each representing one or more destinations. The destinations may be displayed as a list or a drop down list.

At operation 506, a plurality of destinations are selected by the user. The plurality of destinations will be available at a later step for the user to choose. The selection of the plurality of destinations may be done by tapping on the icons representing the destinations or by tapping on the names of the destinations on the list. The selection may be done by any method of making a selection on a touch screen known in the art. Once the plurality of destinations are selected, the selection may remain in the application as the default for all subsequent file transfers until the user decides to select new destinations. Alternatively, the selection of the plurality of destinations may be performed for each file transfer.

At operation 508, a file is displayed on the screen of the device at any time after the plurality of destinations are selected. The file may be a text file, a photo file, an animation file, a video file, or a music file, and may be stored in a primary data storage that is part of the device. The file may be stored in a secondary data storage such as a SD card that is plugged into the device or a cloud storage location. The file may be displayed by the application launched in operation 502, or by a display application not capable of transferring the displayed file to various destinations. In the latter case, the transfer application launched in operation 502 is incorporated in the display application to transfer the displayed file to various destinations. Launching the display application simultaneously launches the file transfer application. The screen of the device may be a touch screen that receives inputs by detecting the presence and the location of a touch within the display screen.

At operation 510, a gesture on the display screen is detected. In one embodiment, the gesture is a swiping motion. The swiping motion may be performed by a finger, or other body parts such as a knuckle or a toe. An object such as a stylus may be used to perform the swiping motion. The length of the swiping motion may range from a very small length representing the slightest movement of the finger to a length crossing the entire display screen. The swiping motion may be performed on any location of the displayed image in any direction. In one embodiment, the swiping motion starts from a location near the bottom of the displayed image and moves away from the bottom. The bottom of the displayed image may not always be the bottom of the device. As the device is rotated 90 degrees, the displayed image does not rotate with the device, thus the bottom of the displayed image is now corresponding to one of the two sides of the device. The swiping motion may be detected in relation to the bottom of the displayed image and not in relation to the bottom of the device.

At operation 512, the plurality of destinations selected in operation 506 are displayed on the screen as the displayed image fades into the background in response to the detecting of the swiping motion in operation 510. One of the destinations may include multiple destinations previously set by the user. The plurality of destinations may be displayed in the periphery of the display screen, leaving an open space in the middle of the display screen. Alternatively, the plurality of destinations may be displayed in rows and each row has multiple destinations. Again, one of the destinations may include multiple destinations previously set by the user. The plurality of destinations may also be displayed in various formats such as a list or a drop-down list.

At operation 514, a selection of a destination is detected. Once the plurality of destinations are displayed in the periphery of the display screen, the user may select the destination by swiping towards that destination from the open space in the middle. The swiping motion in operation 510 and the swiping motion in the current step may be one continuous motion, meaning the user's finger does not leave the display screen between the two swiping motions. For destinations displayed in rows or as a list, the selection of the destination is done by tapping on the icon representing the desired destination or by tapping on the name of the desired destination on the list.

At operation 516, the file that is being displayed on the screen of the device is transferred to the destination selected in operation 514. Depending on the nature of the destination, the file may be transferred to a physical or virtual location, or may be transferred and displayed on a website such as a social network website. The file may be transferred to the destination via one of many protocols or technologies. These protocols and technologies include but not limited to Wi-Fi, Bluetooth, GSM, CDMA, EDGE, 3G, or 4G LTE. Again, the file is transferred from a device to a destination via a gesture such as one or more swiping motion.

In summary, a user of a device may be able to transfer a file from the device to a destination with a gesture such as one or more swiping motion. The destination may be pre-selected. A plurality of destinations may be displayed following the gesture for a user's selection and the file is transferred to the selected destination.

While the forgoing is directed to embodiments described herein, other and further embodiments may be devised without departing from the basic scope thereof. For example, aspects may be implemented in hardware or software or in a combination of hardware and software. One embodiment may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the embodiments described herein, are embodiments described herein.

It will be appreciated to those skilled in the art that the preceding examples are exemplary and not limiting. It is intended that all permutations, enhancements, equivalents, and improvements thereto that are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed is:

1. A method for transferring a file from a device, comprising:
displaying a file on a screen of the device;
detecting a gesture on the screen; and
sending the file to a destination in response to the detecting.

2. The method of claim 1, wherein the file is a photo.

3. The method of claim 1, wherein the gesture is a swiping motion.

4. The method of claim 3, further comprising an image displayed on the screen having a bottom, wherein the detecting the swiping motion comprises detecting a motion from any location on the screen moving away from the bottom of the displayed image.

5. The method of claim 3, wherein the destination has been pre-selected.

6. The method of claim 5, wherein the destination comprises one or more destinations.

7. The method of claim 3, wherein the swiping motion is in a first direction and the file is sent to a first destination.

8. The method of claim 7, wherein the swiping motion is in a second direction and the file is sent to a second destination.

9. A method for transferring a file from a device, comprising:
displaying a file on a screen of the device;
detecting a gesture on the screen;
displaying a plurality of destinations on the screen in response to the detecting;
detecting a selection of one destination; and
sending the file to the selected destination.

10. The method of claim 9, wherein the file is a photo.

11. The method of claim 9, wherein the gesture is a swiping motion.

12. The method of claim 9, wherein the plurality of destinations are displayed in rows on the screen.

13. The method of claim 12, wherein the detecting the selection of the destination comprises detecting a tap on one of the destinations.

14. The method of claim 9, wherein the plurality of destinations are displayed in the periphery of the display screen.

15. The method of claim 14, wherein the detecting the selection of the destination comprises detecting a swiping motion towards one of the destinations.

16. The method of claim 9, wherein one of the plurality of destinations comprises multiple destinations.

17. A non-transitory computer readable storage medium storing instructions that, when executed by a processor, cause the processor to transfer a file to a destination, by performing the steps of:
displaying the file on a screen of a device;
detecting a gesture on the screen; and
sending the file to a destination in response to the detecting.

18. The non-transitory computer readable storage medium of claim 17, wherein the file is a photo.

19. The non-transitory computer readable storage medium of claim 18, wherein the gesture is a swiping motion.

20. The non-transitory computer readable storage medium of claim 19, further comprising an image displayed on the screen having a bottom, wherein the detecting the swiping motion comprises detecting a motion from any location on the screen moving away from the bottom of the displayed image.

21. The non-transitory computer readable storage medium of claim 19, wherein the destination has been pre-selected.

22. The non-transitory computer readable storage medium of claim 21, wherein the destination comprises one or more destinations.

23. The non-transitory computer readable storage medium of claim 19, wherein the swiping motion is in a first direction and the file is sent to a first destination.

24. The non-transitory computer readable storage medium of claim 23, wherein the swiping motion is in a second direction and the file is sent to a second destination.

25. A non-transitory computer readable storage medium storing instructions that, when executed by a processor, cause the processor to transfer a file to a destination, by performing the steps of:
displaying the file on a screen of a device;
detecting a gesture on the screen;
displaying a plurality of destinations on the screen in response to the detecting;
detecting a selection of one of the destinations; and
sending the file to the selected destination.

26. The non-transitory computer readable storage medium of claim 25, wherein the file is a photo.

27. The non-transitory computer readable storage medium of claim 26, wherein the gesture is a swiping motion.

28. The non-transitory computer readable storage medium of claim 25, wherein the plurality of destinations are displayed in rows on the screen.

29. The non-transitory computer readable storage medium of claim 28, wherein the detecting the selection of the destination comprises detecting a tap on one of the destinations.

30. The non-transitory computer readable storage medium of claim 25, wherein the plurality of destinations are displayed in the periphery of the screen.

31. The non-transitory computer readable storage medium of claim 30, wherein the detecting the selection of the destination comprises detecting a swiping motion toward one of the destinations.

32. The non-transitory computer readable storage medium of claim 25, wherein the one of the destinations comprises one or more destinations.
